(19) United States
(12) Patent Application Publication
(10) Pub. No.: US 2007/0196048 A1
(43) Pub. Date: Aug. 23, 2007

(54) Optical waveform shaping

(76) Inventors: Almantas Galvanauskas, Ann Arbor, MI (US); Yogesh Gianchandani, Ann Arbor, MI (US); Liao Kai-Hsiu, Ann Arbor, MI (US); Kabir Udeshi, Mumbai (IN); Long Que, Rexford, NY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/652,947

(22) Filed: Jan. 12, 2007

Related U.S. Application Data
(60) Provisional application No. 60/758,405, filed on Jan. 12, 2006.

(51) Int. Cl. G02B 6/34

(52) U.S. Cl. 385/37

(57) ABSTRACT

A fiber including a fiber grating and at least one refractive index modifier interfacing the fiber grating, the at least one refractive index modifier selectively introducing a refractive-index change on the fiber grating.

### CROSS-REFERENCE TO RELATED APPLICATIONS

This application claims the benefit of U.S. Provisional Application Ser. No. 60/758,405 filed Jan. 12, 2006, which is hereby incorporated by reference in its entirety.

### STATEMENT REGARDING FEDERALLY SPONSORED RESEARCH OR DEVELOPMENT

This invention was made with government support of grant #PHYO114336 awarded by the National Science Foundation. The government has certain rights in the invention.

### FIELD

The present embodiments relate to an optical waveform shaper, and in particular, to an optical waveform shaper using an optical fiber.

### BACKGROUND INFORMATION

Optical pulse shapers input a single short pulse, typically in the femto-second or pico-second range, and output a complex waveform. One such optical pulse shaper includes a diffraction grating pair that relies on spatial effects. The diffraction gratings are used to spread out different spectral components on an optical tabletop. A liquid crystal modulator (LCM) is then used for amplitude and phase tune-up. However, the optical tabletop design is large and requires complex alignment. Moreover, the diffraction grating pair and LCM offer limited use for narrow-band signals. Other systems may include an acousto-optic programmable dispersive filter (DAZZLER). The filter uses an acoustic wave to couple optical waves between two principle polarizations. A piezo-electric transducer may be used to impart acoustic waves into a medium, such as glass, that causes light diffraction in the medium. However, the acousto-optic systems are limited in their time window of operation.

In general, traditional pulse shapers use a diffraction grating providing spatial dispersion and a combination of lenses to spatially image the pulse spectrum in a Fourier plane of the device. The Fourier-transformed light in this plane is passed through a spatial light modulator (SLM), such as a mask, a liquid crystal modulator, an acousto-optic modulator, or a deformable or a micromachined mirror. This allows programmable modification of pulse spectral amplitude and phase and consequently, the temporal shape of a recombined waveform. At least one drawback of this approach is associated with the reliance on spatial dispersion effects. Such devices require complex tolerance-sensitive optical alignment and therefore, are quite challenging from an engineering and manufacturing perspective.

Therefore, it would be advantageous to have a compact pulse shaper that provides a large time window. Moreover, it is desirable to have a programmable device that is suitable for femto-second pulses as well as narrow-band signals (e.g., pico-second pulses). It would also be advantageous to have a pulse shaper that can be powered off when not in operation.

### BRIEF DESCRIPTION OF THE DRAWINGS

FIG. 1 is an exemplary optical wave shaping system.

FIG. 2A is an alternative pulse-shaper embodiment.

FIG. 2B is an exemplary chart of time delay vs. wavelength for the system of FIG. 2A.

FIG. 3 is an exemplary tunable fiber grating for use with the systems of FIGS. 1 and 2.

FIG. 4 is an exemplary actuator for use with the tunable fiber grating of FIG. 3.

FIG. 5 is a cross-sectional view of the actuator of FIG. 4

FIG. 6 is a top perspective view of an exemplary actuator array for use with the tunable fiber grating of FIG. 3.

FIG. 7 is a top perspective close-up view of the exemplary actuator array of FIG. 6.

FIG. 8 shows values of strain generated in the tunable fiber grating of FIG. 3 using a micro-actuator at multiple power levels.

FIG. 9A shows a comparison between measured and numerically predicted spectral responses of the tunable fiber grating of FIG. 3 due to the action of a single electrothermal actuator.

FIG. 9B shows the position of actuator along the tunable fiber grating of FIG. 3 with respect to the comparison of FIG. 9A.

FIG. 9C shows differences in the spectral responses when actuators at different longitudinal positions are engaged on the tunable fiber grating of FIG. 3.

FIG. 9D shows a negligible thermal effect of heat from an actuator on the tunable fiber grating of FIG. 3.

FIG. 9E shows autocorrelation-measured pulse duration dependence vs. applied actuator-driving power from the tunable fiber grating of FIG. 3.

FIG. 10 is a spectrum map of the tunable fiber grating of FIG. 3.

FIG. 11 shows a strain distribution in a cross section of the tunable fiber grating of FIG. 3.

FIG. 12 shows a strain mapping at the core of the tunable fiber grating of FIG. 3 vs. applied force by the actuator of FIG. 4.

FIG. 13 shows a Finite Element Analysis calculated longitudinal strain profile for the tunable fiber grating of FIG. 3.

FIG. 14 shows a chart of strain at the core of the tunable fiber grating of FIG. 3 vs. the driving power of the actuator of FIG. 4.

FIG. 15 shows a fiber grating of four point five millimeters (4.5 mm) in length where an actuator is positioned at one point eight millimeters (1.8 mm) from the end.

FIG. 16 shows the response of fiber grating of FIG. 15 when no power is applied to the actuator.

FIG. 17 shows the response of the fiber grating of FIG. 15 when two hundred milliwatts (200 mW) of power is applied to the actuator.

FIG. 18 shows the response of the fiber grating of FIG. 15 when four hundred milliwatts (400 mW) of power is applied to the actuator.

FIG. 19 shows a fiber grating of four point five millimeters (4.5 mm) in length where an actuator is positioned at one point zero eight millimeters (1.08 mm) from the end.

FIG. 20 shows the spectral response of the fiber grating of FIG. 19 where no power is applied to the actuator and alternatively where six hundred six milliwatts (606 mW) is applied to the actuator.

FIG. 21 shows a fiber grating of four point five millimeters (4.5 mm) in length where an actuator is positioned at two point seven six millimeters (2.76 mm) from the end.

FIG. 22 shows the spectral response of the fiber grating of FIG. 21 where no power is applied to the actuator and alternatively where five hundred sixty milliwatts (560 mW) is applied to the actuator.

FIG. 23 shows an input pulse for the system of FIG. 1.

FIG. 24 shows an output pulse of the system of FIG. 1 after transformation of the input pulse of FIG. 23.

FIG. 25 shows a normalized intensity of autocorrelation traces as the result of time domain pulse shaping from the system of FIG. 1.

FIG. 26 shows a chart of pulse duration vs. actuator driving power for the system of FIG. 1.

FIG. 27 shows measured and simulated autocorrelation traces for the system of FIG. 1 where the actuator is unpowered.

FIG. 28 shows measured and simulated autocorrelation traces for the system of FIG. 1 where the actuator is powered.

FIG. 29 shows an example of the signal spectrum at the output of the system of FIG. 1.

FIG. 30 shows autocorrelation trace profiles of transform limited and shaped pulses corresponding to the output spectrum of FIG. 29.

FIG. 31 shows an input pulse and an output pulse where the actuators are driven in a sinusoidal driving profile. P FIG. 32 shows the phase response where the input pulse is split into a pulse train by applying sinusoidal actuator driving profile.

FIG. 33 shows a pulse shape and phase response for a four nanometer bandwidth signal.

FIG. 34 shows a pulse shape and phase response for a twenty nanometer bandwidth signal.

FIG. 35 shows an example of creating a desired pulse shape by finding a required phase response of the grating through an iterative Fourier transform algorithm using the system of FIG. 1.

FIG. 36 shows an alternative embodiment for an actuator that is a bistable latching mechanism.

FIG. 37 shows a reaction force/displacement curve for the bistable latching mechanism of FIG. 36.

### DETAILED DESCRIPTION

Disclosed is a programmable optical pulse shaper using a fiber grating and a micromachined array of silicon (Si) actuators on a one by five square millimeter (1×5 mm²) chip. The pulse spectrum is spatially imaged along a chirped fiber Bragg grating, in an example, thus permitting each spectral component inside the fiber to be accessed by individual actuators. The micro-actuators can tune the refractive index of the grating by inducing localized strain gradients. They are fabricated on a silicon microchip using a lithographic process. In addition to the practicality of a compact and robust implementation, this approach offers the important ability to produce very large and controllable phase shifts. Pulse shaping is demonstrated by a controlled pulse spectrum and temporal-width changes from one point five (1.5) to four (4) pico-seconds (ps).

Programmable shaping of optical waveforms is needed for a number of scientific studies. One example is the coherent control of chemical reactions and quantum computing. However, other applications are identifiable, including but not limited to, optical signal processing, optical communications, radar arrays, Higher-order dispersion-mismatch compensation in CPA stretcher/compressor, programmable dispersion compensation in fiber communication links, encoder/decoder of optical CDMA system, and ultrashort pulse lasers, to name a few.

Disclosed herein are embodiments using a micromachined fiber-optic pulse-shaper in which light is controlled inside an optical fiber, without resorting to external spatial beam manipulation and thus, permitting compact and robust programmable light-control technology. The device uses an on-chip micro-actuator array, which produces local strain gradients in an embedded chirped fiber Bragg grating (CFBG). This approach enables programmable control of uniquely large phase shifts, thus permitting adjustable dispersion control, variable time delays, and arbitrary optical waveform generation on a femtosecond-to-subnanosecond time scale.

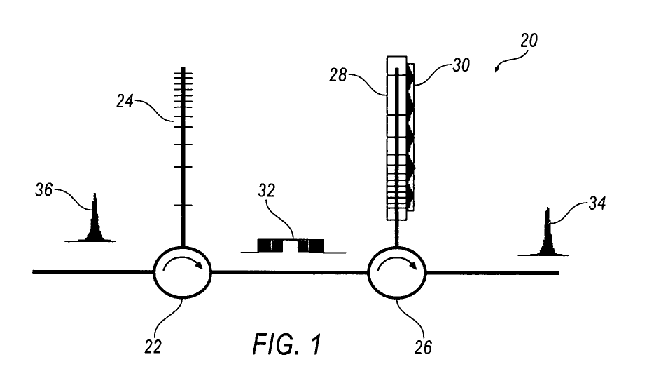

FIG. 1 is an exemplary optical wave shaping system 20 including a first circulator 22, a stretching fiber Bragg grating 24, a second circulator 26, and a compressing tunable chirped fiber grating 28. Compressing tunable chirped fiber grating 28 further includes an actuator array 30 that is discussed in detail below. Stretching fiber Bragg grating 24 and compressing tunable chirped fiber grating 28 are identical in their Bragg characteristics. However, they are reciprocally mounted to first circulator 22 and second circulator 26, such that an optical pulse input 36 is expanded by stretching fiber Bragg grating 24, but is then compressed by compressing tunable chirped fiber grating 28. Moreover, compressing tunable chirped fiber grating 28 is adjustable. Indeed, compressing tunable chirped fiber grating 28 is programmable to provide optical pulse shaping of a stretched pulse 32. The shape of an output 34 will depend upon the commanded characteristics of tunable chirped fiber grating 28.

Generally, in a fiber Bragg grating, light is reflected if its wavelength satisfies the Bragg condition: λ_{B}=2nΛ(z), where λ_{B} is the wavelength reflected at position z, Λ(z) is the local grating period and n is the effective refractive index for the propagating mode in the fiber core. In a linearly chirped fiber grating this local period varies linearly along the length of the fiber, producing a linear frequency chirp in a reflected optical pulse (i.e., a linearly varying delay as function of optical wavelength).

Optical wave shaping system 20 is made using a pair of chirped fiber gratings (CFBGs) (e.g., stretching fiber Bragg grating 24 and compressing tunable chirped fiber grating 28) oriented with opposing spatial chirp direction and connected to all-fiber circuitry through first circulator 22 and second circulator 26. Stretching fiber Bragg grating 24 stretches the incident bandwidth-limited pulse (e.g., optical pulse input 36) and tunable chirped fiber grating 28 compresses stretched pulse 32 back to the bandwidth-limited duration. This reciprocity between pulse stretching and compressing requires both gratings to be identical to each other. Pulse shaping of the re-compressed pulse then can be achieved if this reciprocity is “broken” by inducing refractive index modulation in one of the gratings. As explained in detail below, tunable chirped fiber grating 28 includes mechanisms for selectively introducing refractive index modulation into a fiber Bragg grating.

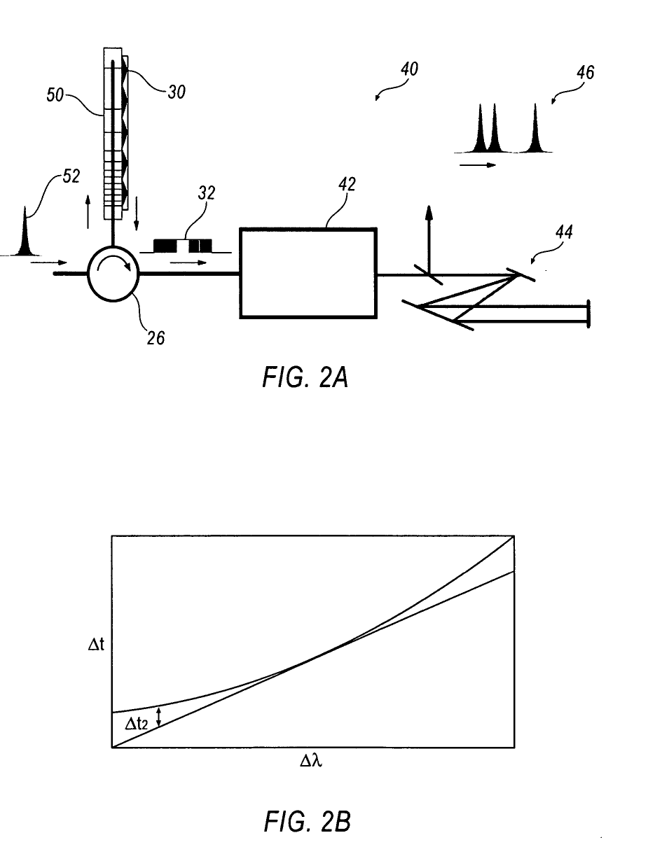

FIG. 2A is pulse-shaper embodiment 40 including a diffraction-grating compressor 44. This particular embodiment is useful when compressed pulses 52 are provided by an amplifier. Further, compressed pulses 52 may have too high a peak power to be compressed in a fiber grating. For example, pulse-shaper embodiment 40 may be used for fiber-based chirped pulse amplification systems. In this configuration, shaped pulses may be generated with high pulse energies. Furthermore, pulse-shaper embodiment 40 may also be used to produce bandwidth-limited pulses from a chirped-pulse amplification system where pulses are stretched and compressed using dispersion mismatched pulse stretchers and compressors. For example, using a fiber grating stretcher 50 and diffraction-grating compressor 44, as shown in FIG. 2A. Pulse-shaper embodiment 40 is used to produce phase response compensating higher-order dispersion mismatch between chirped fiber grating 50 and diffraction-grating compressor 44. Additionally, pulse-shaper embodiment 40 may also be used to compensate for a mismatch occurring due to nonlinear effects in the amplifier.

FIG. 2B is an exemplary chart of time delay vs. wavelength for the system of FIG. 2A. In an example, the setup comprises a ten nanometer (10 nm) bandwidth, a one thousand five hundred fifty nanometer (1550 nm) signal, and a one thousand two hundred (1200) line/mm diffraction grating. Thus, a ten centimeter (10 cm) CFBG can provide up to approximately one hundred picoseconds (˜100 ps) of adjustable time delay. An amplifier 42 receives a modulated output (e.g., stretched pulse 32) and a grating assembly 44 further modifies the signal to a shaped output 46.

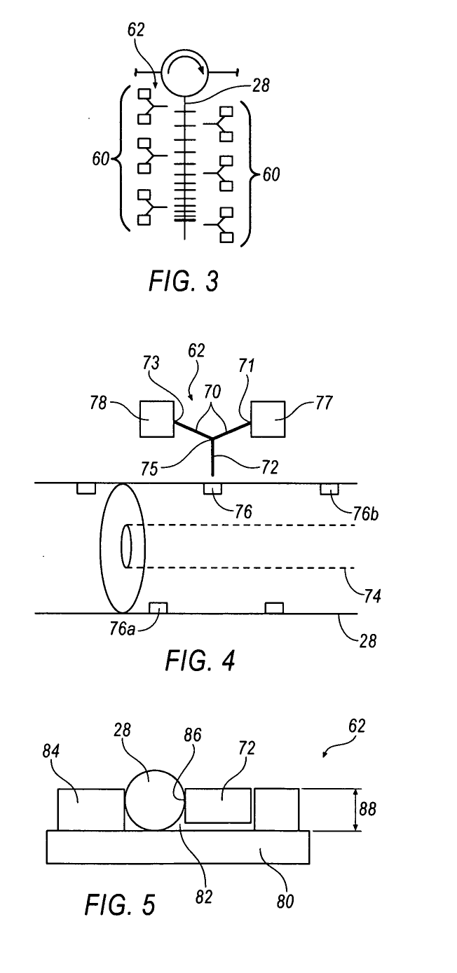

FIG. 3 is an exemplary tunable chirped fiber grating 28 for use with the systems of FIGS. 1 and 2. An actuator array 60 of electrothermal micro-actuators 62 locally alter the refractive index of tunable chirped fiber grating 28. Micro-actuators 62 are spaced along tunable chirped fiber grating 28 such that they may address individual components of the optical spectrum along the length of tunable chirped fiber grating 28. As explained below in detail, micro-actuators 62 are programmable and provide selective introduction of refractive index modulation into tunable chirped fiber grating 28.

FIG. 4 is an exemplary actuator 62 for use with the tunable chirped fiber grating 28 of FIG. 3. In general, actuator array 60 is a Micro-Electro-Mechanical Systems (MEMS) device that uses electro-thermal force actuators 62 to displace an actuator beam 72 that applies force upon fiber tunable chirped fiber grating 28 at a force pixel location 76 (e.g., a fiber Bragg grating, such as the fiber of tunable chirped fiber grating 28). Actuator beam 72 applies force to the cladding layer of fiber tunable chirped fiber grating 28 and does not directly apply force to a fiber core 74.

Although only a single actuator 62 is shown for clarity, other actuators are also positioned such that they may interface tunable chirped fiber grating 28 at force pixels 76a, 76b, etc. In addition to electro-thermal force actuators, other types of actuators are also used. For example, actuators may include a strain-induced refractive index change, piezo actuators, evanescent field access, electro-capacitance, and electro-thermal. Thus, actuators 62 are not merely limited to electro-thermal devices. Force pixel locations 76 (and the associated actuators 62) are spaced at sixty micro-meter (60 μm) intervals where the fiber tunable chirped fiber grating 28 is four point eight millimeters (4.8 nm) long. The length of each force pixel location 76 is five micrometers (5 μm). The diameter of fiber tunable chirped fiber grating 28 is eighty micrometers (80 μm).

In the embodiments herein, local modification of the refractive index of a fiber grating may be performed by actuators 62. In a mechanical manner, actuators 62 introduce strain into a fiber. Thus, actuators 62 behave as a refractive index modifier interfacing the fiber grating. In addition to mechanically introducing strain into a fiber grating to locally modify the refractive index, other refractive index modifiers are contemplated. For example, exposing the optical field of a fiber core to a proximity actuator allows for direct modification of the fiber core optical field.

Micro-actuators 62 are, in an embodiment, constructed from suspended V-shaped beams 70, clamped at their two ends 71, 73 to anchors 77, 78. When a stimulus is applied (e.g., an electrostatic potential is applied) across ends 71, 73 of beams 70, the current through them causes Joule heating and consequent expansion. An apex 75 of the expanded beam is pushed outward, generating a displacement and force in beam 72. Micro-actuators 62 generate rectilinear displacements with forces up to the milli-Newton range and can be fabricated from any material that is electrically conductive and has sufficient mechanical strength. Typical electrothermal micro-actuators have operating frequencies from DC to the kilohertz range. The stimulus, as discussed above, may for example, but not limited to, a voltage, a current, a waveform, or other means for controlling or modifying the behavior of actuator 62.

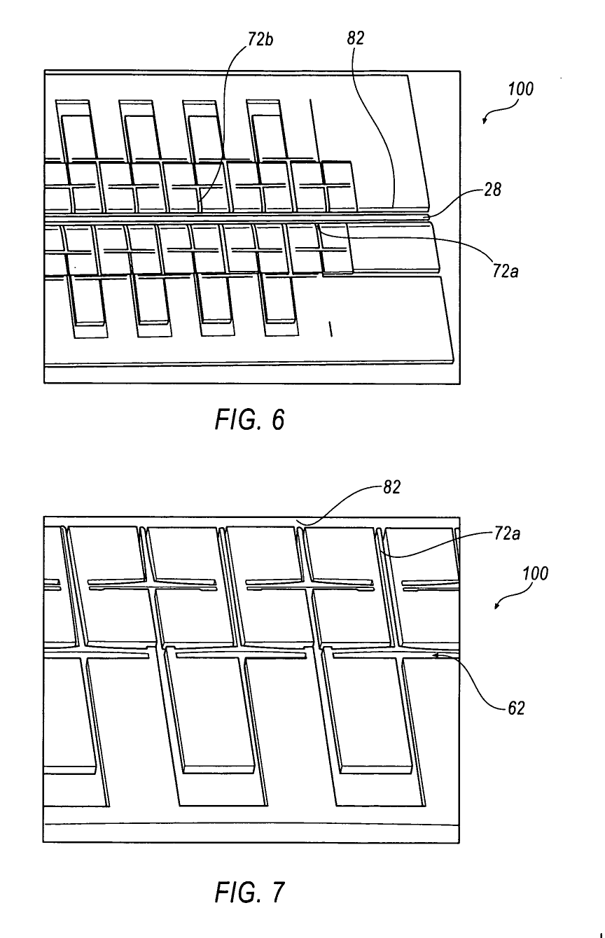

FIG. 5 is a cross-sectional view of actuator array 60 of FIG. 3, and in particular an actuator 62 of FIG. 4. A substrate 80 is provided for the construction of actuator 62 and is typically silicon or glass. Tunable chirped fiber grating 28 is placed within array 60 in a channel 82 and is bounded on either side by a stop 84 and actuator beam 72. An actuator beam tip 86 is configured such that force is applied to tunable chirped fiber grating 28 and the force is through the center of tunable chirped fiber grating 28. The height 88 of actuator beam 72 should be at least one half the diameter of tunable chirped fiber grating 28. In the case where tunable chirped fiber grating 28 has a diameter of eighty micrometers (80 μm); the height 88 of actuator beam 72 is forty micrometers (40 μm). Additionally, actuator beam 72 includes a flat face of beam tip 86 allowing for variation in fiber diameter.

FIG. 6 is a top perspective view of an exemplary actuator array 100 for use with the tunable chirped fiber grating of FIG. 3. Tunable chirped fiber grating 28 lies within channel 82 and actuator beams 72a, 72b, etc., may interface with the fiber's cladding. Each actuator 62 can be individually electronically addressed and controlled for selective application of force. Micro-actuator array 100, in an example, has overall dimensions of five millimeters by one millimeter (5 mm×1 mm). Although not all actuators are shown, seventy five (75 actuators 62 are provided and spaced at sixty micro-meter (60 μm) intervals. Micro-actuator array 100 is fabricated from doped silicon using deep reactive ion etching (DRIE). A two-mask process results in fifty micrometer (50 μm) thick devices bonded to, in an embodiment, a glass substrate 80 (see FIG. 5). Tunable chirped fiber grating 28 is inserted into channel 82 of actuator array 100 and is held in place with an adhesive. The dimensions of the groove are chosen so that the eighty micro-meter (80-μm) outer-diameter of tunable chirped fiber grating 28 fits snugly in channel 82, with beam tip 86 touching tunable chirped fiber grating 28.

Compressing tunable chirped fiber grating 28 is inserted into channel 82 that is created between arrays of electrothermal micro-actuators 62. By using electrothermal micro-actuators 62, a localized and controlled amount of force may be applied on tunable chirped fiber grating 28. This applied force results in a compressively strained region in the glass, which according to the finite-element numerical model calculation has a full-width-at-half-maximum (FWHM) of eighty micro-meters (80 μm). The strain locally modifies the refractive index of the grating, and consequently, the Bragg wavelength is reflected in this region (at a rate ˜1.2-pm/μStrain). By altering the force applied by electrothermal actuator 62, the magnitude of the local Bragg-wavelength shift can be controlled.

The use of an array of actuators 62 allows different spectral components along the length of the tunable chirped fiber grating 28 to be addressed. Small shifts in the localized Bragg wavelengths do not produce any observable changes in the amplitude reflection spectrum of the grating, but can produce large phase shifts, i.e. tunable chirped fiber grating 28 acts as a phase-only modulator. Only the application of excessively large local strains can change the amplitude reflection spectrum of tunable chirped fiber grating 28. Since the latter causes simultaneous amplitude and phase coupling, operation of this pulse shaper is used only as a phase-only modulator, i.e. to be controlled only by small strain values.

FIG. 7 is a top perspective close-up view of the exemplary actuator array 100 of FIG. 6. As discussed above, actuator array 100 includes a fifty micrometer (50 μm) deep and an eighty micrometer (80 μm) wide fiber channel 82 for tunable chirped fiber grating 28 to be placed into and secured. Beams 72 are part of electro-thermal actuators 62 driven by thermal expansion. In operation, the heat generated by selective movement of beams 72 is dissipated through the case. Moreover, beam 72 may impart a force of at least 10 milliNewtons (10 mN) to each force pixel location 76 (see FIG. 4). Moreover, because actuator array 100 is electrically controllable, the reprogramming time for the entirety of the blazer micro-actuator array 100 may be reprogrammed quickly. For example, each and every actuator 62 of micro-actuator array 100 may be reprogrammed within a millisecond. Thus, the behavior of tunable chirped fiber grating 28 may also be changed in that time frame. It is also expected that faster responses are achievable with optimizations to micro-actuator array 100.

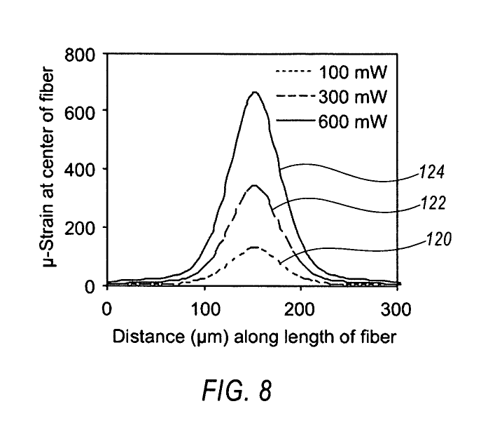

FIG. 8 shows values of strain generated in tunable chirped fiber grating 28 using a micro-actuator 62 at a first power level 120 of one hundred milliwatts (100 mW), a second power level 122 of three hundred milliwatts (300 mW), and third power level 124 of six hundred milliwatts (600 mW).

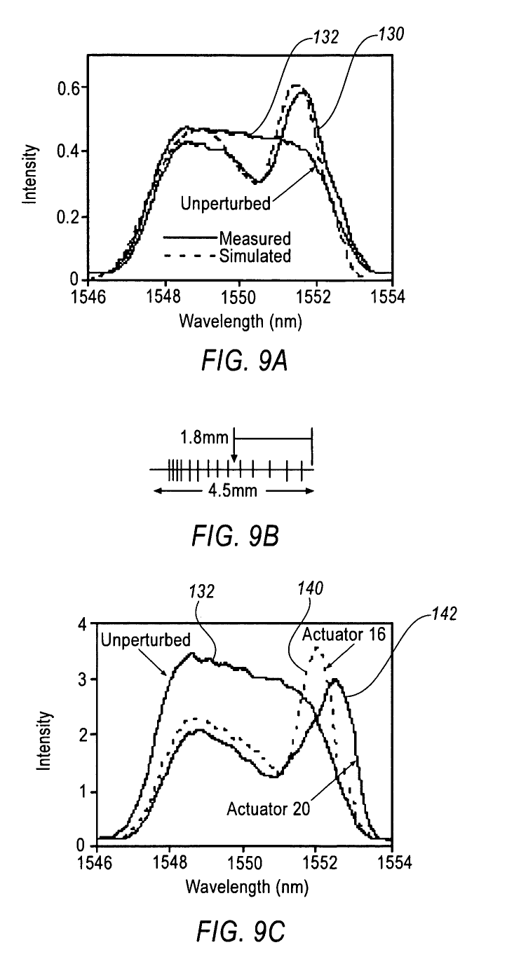

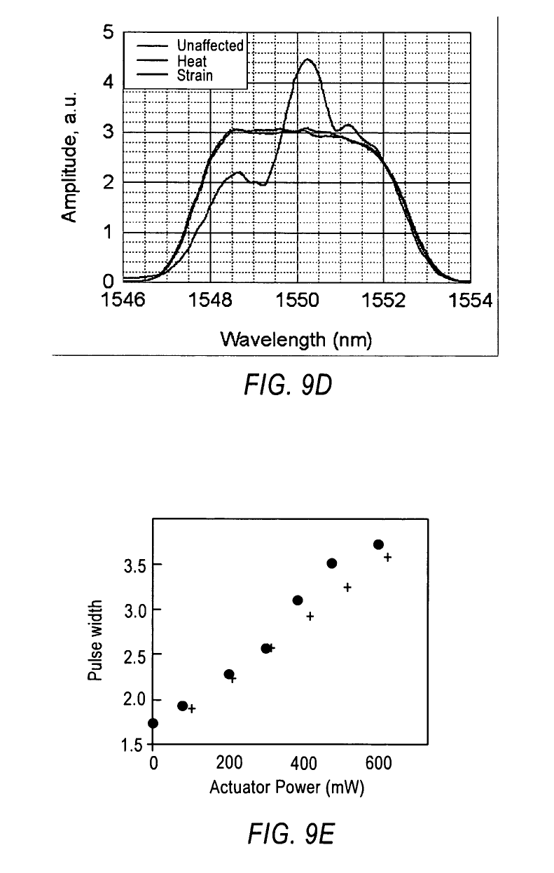

FIG. 9A shows a comparison between a measured and numerically predicted spectral responses of a perturbed 130 tunable chirped fiber grating 28 to the action of a single electrothermal actuator 62. FIG. 9B shows the position of actuator 62 along tunable chirped fiber grating 28 as one point eight millimeters (1.8 mm) along a four point five millimeter (4.5 mm) tunable chirped fiber grating 28. An unperturbed trace 132 shows the reflection spectra of the unperturbed tunable chirped fiber grating 28. For both perturbed 130 and unperturbed 132 cases, the solid lines correspond to measured responses, while dashed lines correspond to modeled responses.

FIG. 9C shows measured reflection spectra, showing a distinct difference in the spectral responses when actuators at different longitudinal positions are engaged. Here, actuators sixteen (16) and twenty (20) are separated by two hundred forty micrometers (240 μm). The optical spectrum 140, 142 obtained by the activation of actuators (16) and twenty (20), respectively, along the length of tunable chirped fiber grating 28 illustrate the distinct change in optical spectrum obtained using actuators only two hundred forty micrometers (240 μm) apart when activated with five hundred milliwatts (500 mW) of power. The distinct optical spectrum obtained by the use of separate actuators confirms that the spatially separated actuators are capable of addressing distinct portions of the optical spectrum.

Changes in the temporal shape of an optical pulse caused by the action of a single actuator 62 have been also measured using standard second-harmonic autocorrelation technique (see FIG. 9A). Temporal broadening of the observed pulse from one point five picoseconds (1.5 ps) to four picoseconds (4 ps) occurs as the pressure applied through actuator 62 is increased.

FIG. 9D shows a negligible thermal effect of heat from actuator 62 on tunable chirped fiber grating 28. Temperature may also have a profound effect on the optical response of tunable chirped fiber grating 28. Thus, experimental confirmation was obtained that the spectral response obtained by driving actuators 62 is due to mechanical strain and that the effect of Joule heat dissipated by the electrothermal actuators is negligible. Indeed, the temperature at beam tip 86 of the actuator is close to room temperature, as substantially all of the heat generated by micro-actuators 62 is conducted away to substrate 80. In the heating experiment, a needle, heated to about three hundred fifty degrees Celsius (350° C.), was brought into contact with tunable chirped fiber grating 28, and produced no noticeable change in the optical spectrum. As shown in the chart, the spectral change due to thermal effect is negligible compared to force-actuator induced change.

FIG. 9E shows autocorrelation-measured pulse duration dependence vs. applied actuator-driving power. The full-width-at-half-maximum (FWHM) of the optical pulses increases from one point five picoseconds (1.5 ps) to over four picoseconds (4 ps), with an increase in the micro-actuator 62 power. The corresponding peak strains in the fiber are shown.

Turning now back to FIG. 1, the optical response of tunable chirped fiber grating 28 can be accurately controlled by micromachined actuator array 30. In the setup, stretching fiber Bragg grating 24 and compressing tunable chirped fiber grating 28 are connected in a reciprocal configuration. Linearly chirped fiber Bragg gratings with approximately five nanometer (˜5 nm) spectral bandwidths at one thousand five hundred fifty nanometer (1550 nm) central wavelength are used, for example, in the embodiment. Stretching fiber Bragg grating 24 and compressing tunable chirped fiber grating 28 were apodized, providing a generally smooth reflection spectrum profile. Grating reflectivity was approximately fifty percent (˜50%). The laser pulses were generated using an Er-doped mode-locked fiber laser. Actuators 62 in the actuator array 30 were individually addressed from one (1) to seventy five (75) along the length of the grating (i.e., actuator array 30 contained seventy five (75) individual actuators 62 and each is addressed linearly along the length of compressing tunable chirped fiber grating 28).

The chirped grating reflection spectrum amplitude and phase has been modeled using the effective-index method, with the apodization profile included into the grating model. Calculation of the fiber grating response to the action of a single or multiple MEMS actuators 62 included both mechanical and optical effects. The local strain profile induced inside the fiber by a single micro-actuator has been calculated using a finite element analysis, permitting the calculation of the local refractive-index change using known elasto-optic coefficients for fused silica glass at every specific actuator location. Consequently, by including this change into the effective-index model of the chirped grating, the effect of each individual actuator on the total grating reflection characteristics (to both amplitude and phase) could be calculated.

Comparison between experimentally measured and numerically predicted grating responses for the action of a single actuator 62 is shown in FIGS. 9A-9E and represents agreement between experimental results and theoretical results. This response has been obtained with a single actuator 62, whose position with respect to the chirped grating is noted in FIG. 9B. By applying a very large strain through actuator 62, the grating reflection spectrum was significantly modified at the spectral position approximately corresponding to the actuator's longitudinal position. Such comparison has been performed for various actuator positions operating at a variety of driving powers.

Good agreement, similar to the one shown in FIG. 9A, has been observed in all these cases, proving that indeed, a reproducible and accurately controlled chirped grating response has been achieved in this fiber-MEMS integrated device. Note that use of such high strains (and corresponding driving powers) with accompanying amplitude change in the reflection spectrum is not intended for the “regular” pulse shaping operation and was used here merely for testing and demonstration purposes. Indeed, ten times to one hundred times (10×-100×) weaker strains are sufficient to achieve phase-only modification of a fiber grating response.

Phase-only pulse shaping is determined using the formula below where A(t) is the desired pulse shape and iΔ(ω) is the tunable phase. Shaping is achieved through phase-only modulation where the power spectrum is unchanged using serial spectral-phase access.

$$A ( t ) = {\vert \frac{1}{2 π} \int {E}_{i n} ( ω ) {ⅇ}^{ⅈΔ ( ω )} \cdot {ⅇ}^{- ⅈω t} ⅆ ω \vert}^{2}$$

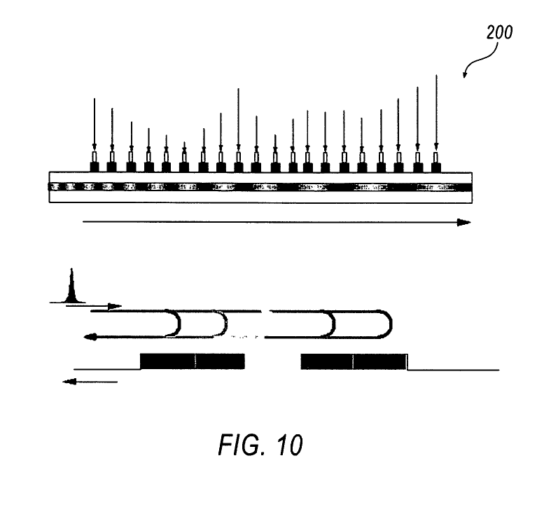

FIG. 10 is a spectrum map 200 of tunable chirped fiber grating 28 of FIG. 3. Actuator array 30 selectively applies force to tunable chirped fiber grating 28 and alters the pulse spectrum as mapped along the chirped fiber grating. Each micro-actuator 62 locally modifies the refractive index (spectral component phase) of tunable chirped fiber grating 28. Thus, different frequencies are reflected in tunable chirped fiber grating 28 at different positions. The Electro-thermal MEMS micro-actuators 62 locally access and modify different frequency components of tunable chirped fiber grating 28 to create a phase shift.

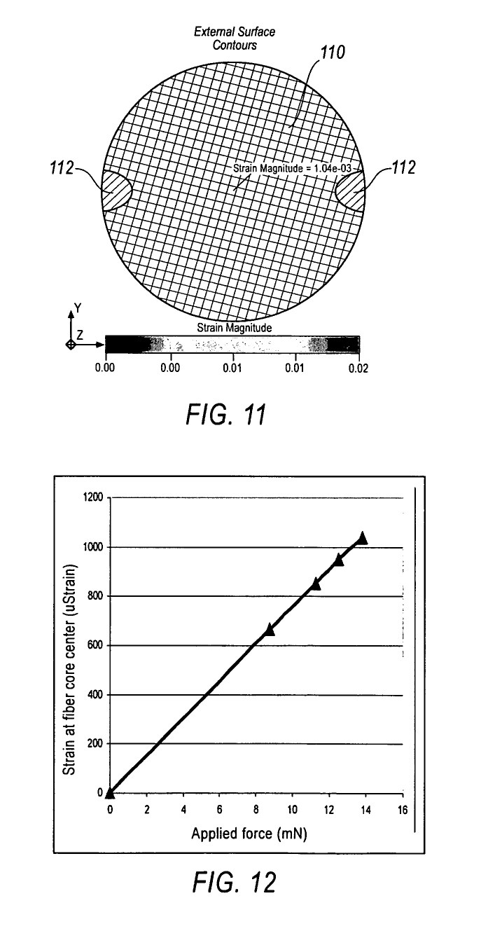

FIG. 11 shows a strain distribution in a cross section of tunable chirped fiber grating 28 where the fiber diameter is eighty micrometers (80 μm). In an example, the strain at the center of fiber 110 is near zero (e.g., one point zero four times ten to the negative three (1.04 e-03)). Closer to the perimeter of fiber 110, where actuator array 30 selectively applies force, strain zones 112 have an approximate strain of zero point zero one (0.01).

FIG. 12 shows a strain mapping at the tunable chirped fiber grating 28 core vs. applied force by actuator 62.

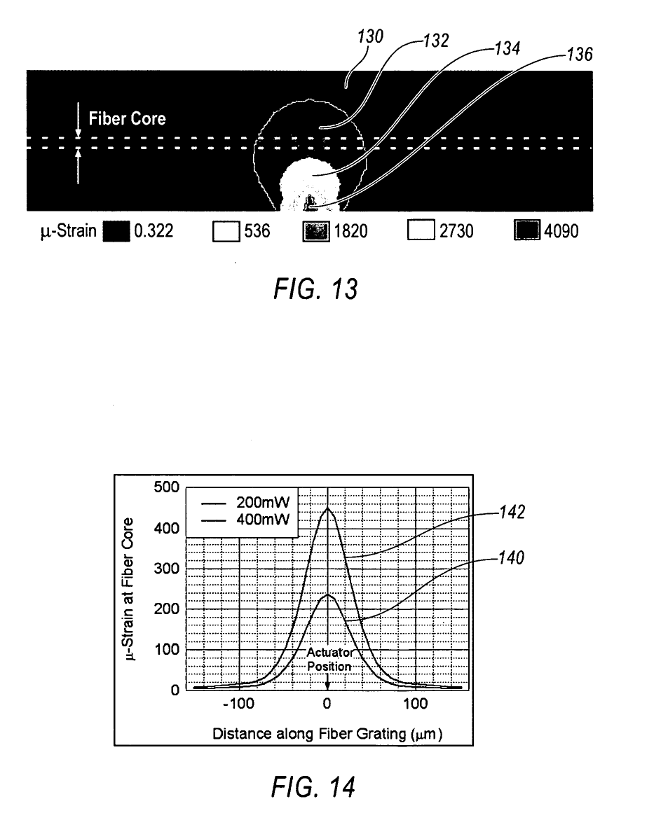

FIG. 13 shows a Finite Element Analysis (FEA) calculated longitudinal strain profile for tunable chirped fiber grating 28. First strain zone 130 has approximately zero point three two two micro strain (0.322 μ-strain). Second strain zone 132 has approximately five hundred thirty six micro strain (536 μ-strain). Third strain zone 134 has approximately two thousand seven hundred thirty micro strain (2730 μ-strain). Fourth strain zone 136 has approximately four thousand ninety micro strain (4090 μ-strain).

FIG. 14 shows a chart of strain at the tunable chirped fiber grating 28 core vs. driving power of actuator 62. In this embodiment, two hundred milliwatts (200 mW) of driving power results in approximately two hundred twenty (˜220) micro-strain in the fiber core as shown in trace 140; four hundred milliwatts (400 mW) of driving power results in approximately four hundred fifty (˜450) micro-strain in the fiber core as shown in trace 142.

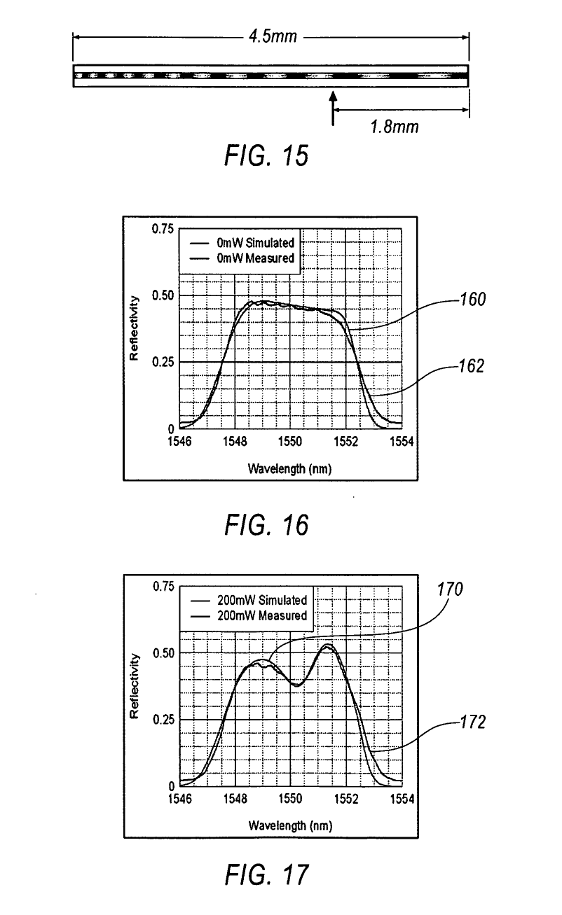

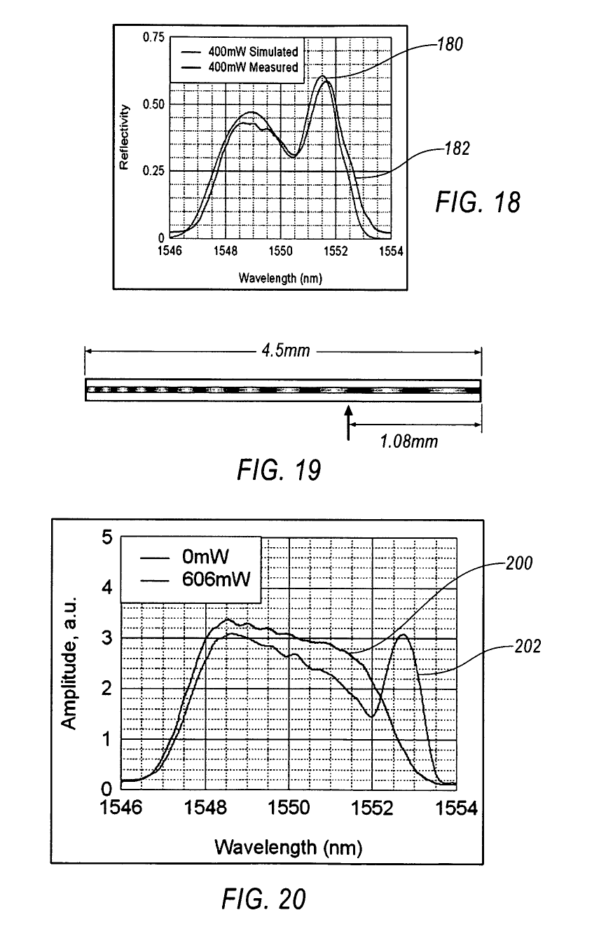

FIGS. 15-18 show by way of example a comparison of spectral response of the tunable chirped fiber grating 28 with a single actuator. FIG. 15 shows tunable chirped fiber grating 28 being four point five millimeters (4.5 mm) in length where actuator 62 is positioned at one point eight millimeters (1.8 mm) from the end. FIG. 16 shows the response of tunable chirped fiber grating 28 when no power is applied to actuator 62. Trace 160 shows a simulated result and trace 162 shows a measured result. FIG. 17 shows the response of tunable chirped fiber grating 28 when two hundred milliwatts (200 mW) of power is applied to actuator 62. Trace 170 shows a simulated result and trace 172 shows a measured result. FIG. 18 shows the response of tunable chirped fiber grating 28 when four hundred milliwatts (400 mW) of power is applied to actuator 62. Trace 180 shows a simulated result and trace 182 shows a measured result.

FIG. 19 shows tunable chirped fiber grating 28 having four point five millimeters (4.5 mm) in length where actuator 62 is positioned at one point zero eight millimeters (1.08 mm) from the end. FIG. 20 shows the spectral response of tunable chirped fiber grating 28 of FIG. 19 where no power is applied to actuator 62 (see trace 200) and alternatively where six hundred six milliwatts (606 mW) is applied to actuator 62 (see trace 202).

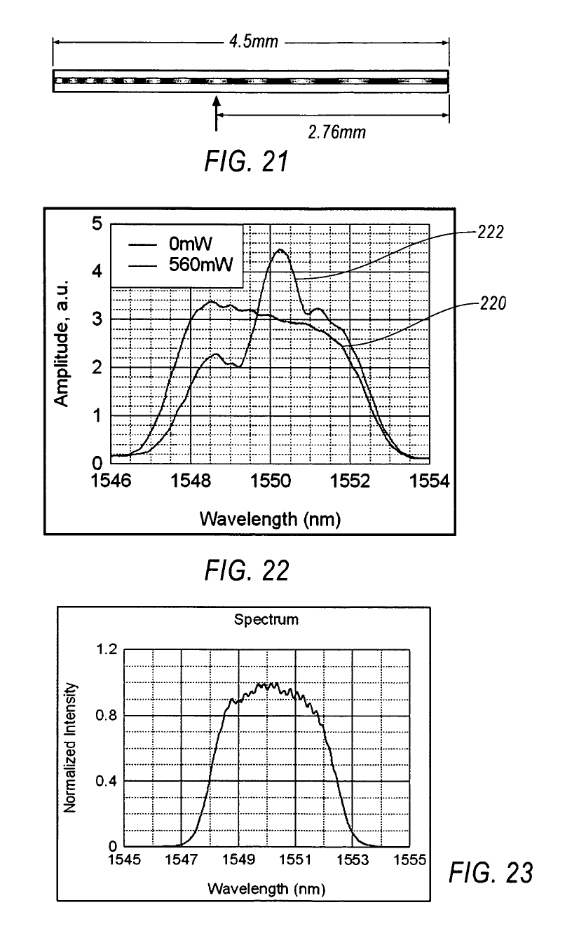

FIG. 21 shows tunable chirped fiber grating 28 having four point five millimeters (4.5 mm) in length where actuator 62 is positioned at two point seven six millimeters (2.76 mm) from the end. FIG. 22 shows the spectral response of tunable chirped fiber grating 28 of FIG. 21 where no power is applied to actuator 62 (see trace 220) and alternatively where five hundred sixty milliwatts (560 mW) is applied to actuator 62 (see trace 222).

FIG. 23 shows an input pulse of the system of FIG. 1.

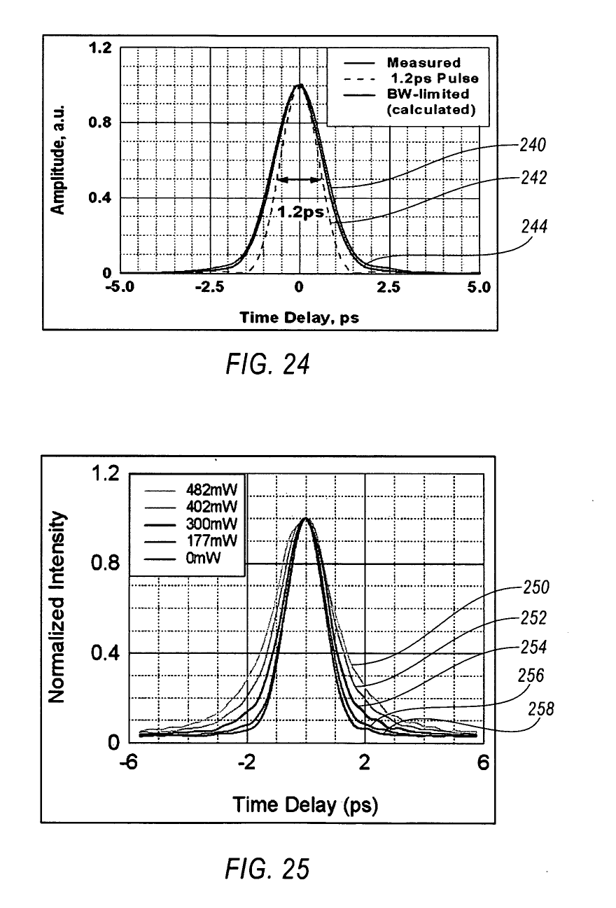

FIG. 24 shows an output pulse of the system of FIG. 1 after transformation. It is important to note that identical fiber gratings 24, 28 are used with opposite orientation to ensure a transform limited 242 output pulse. As shown, the measured output pulse 240 is transform limited 244.

FIG. 25 shows a normalized intensity of autocorrelation traces as the result of time domain pulse shaping from the system of FIG. 1. Trace 250 shows a response where four hundred eighty two milliwatts (482 mW) is applied to actuator 62. Trace 252 shows a response where four hundred two milliwatts (402 mW) is applied to actuator 62. Trace 254 shows a response where three hundred milliwatts (300 mW) is applied to actuator 62. Trace 256 shows a response where one hundred seventy seven milliwatts (177 mW) is applied to actuator 62. Trace 258 shows a response where no power is applied to actuator 62.

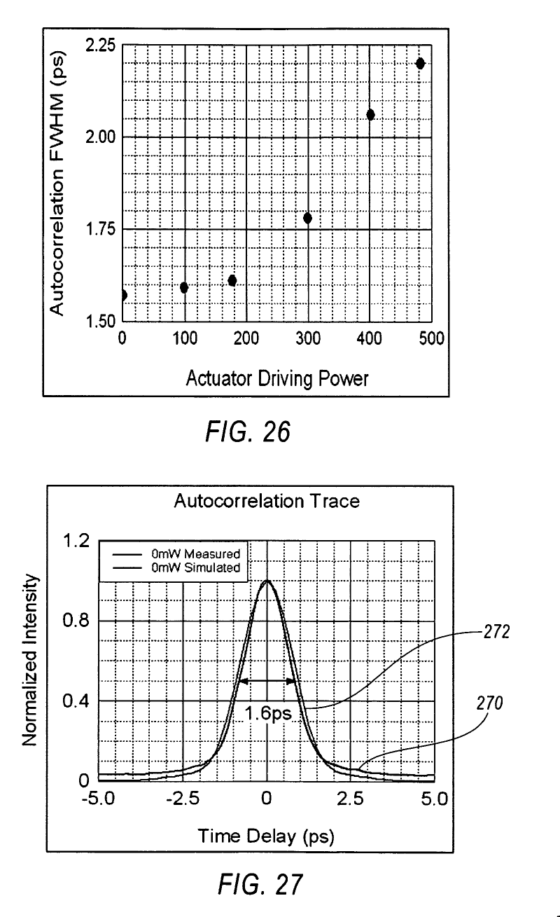

FIG. 26 shows a chart of pulse duration vs. actuator driving power for the system of FIG. 1.

FIG. 27 shows measured and simulated autocorrelation traces for the system of FIG. 1, where actuator 62 is unpowered. Trace 270 is simulated and trace 272 is measured.

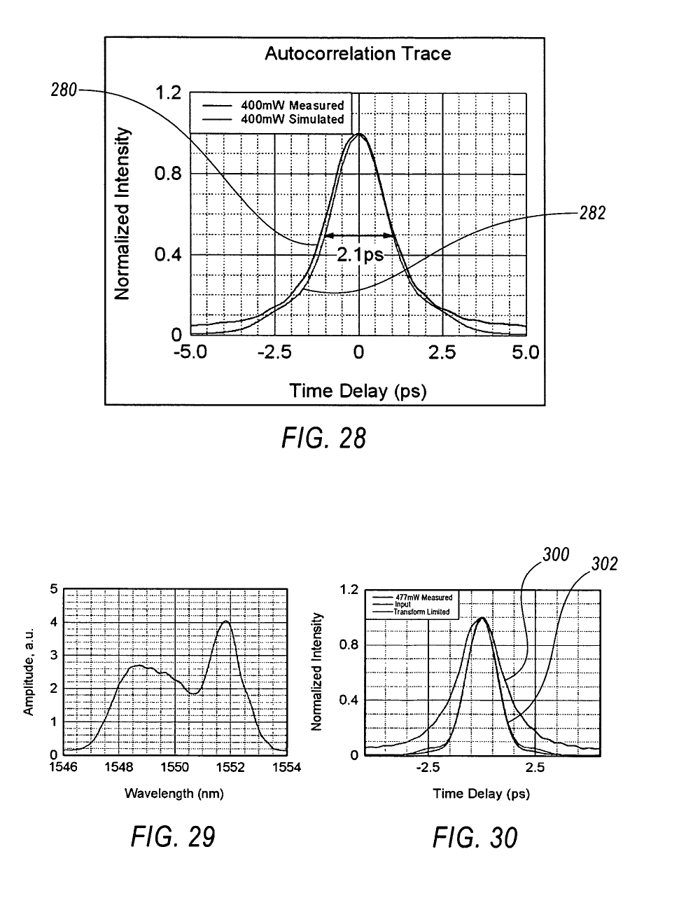

FIG. 28 shows measured and simulated autocorrelation traces for the system of FIG. 1 where four hundred milliwatts (400 mW) is applied to actuator 62. Trace 280 is measured and trace 282 is simulated.

FIG. 29 shows an example of the signal spectrum at the output of the system of FIG. 1.

FIG. 30 shows autocorrelation trace profiles of transform limited and shaped pulses corresponding to the output spectrum of FIG. 29. A transform limited pulse trace 302 is calculated using the spectrum in FIG. 29 assuming zero-phase (no-shaping); and a measured trace 300 of a shaped pulse is obtained when four hundred seventy seven milliwatts (477 mW) is applied to actuator 62. The broadening of the modulated output is induced by phase rather amplitude modulation.

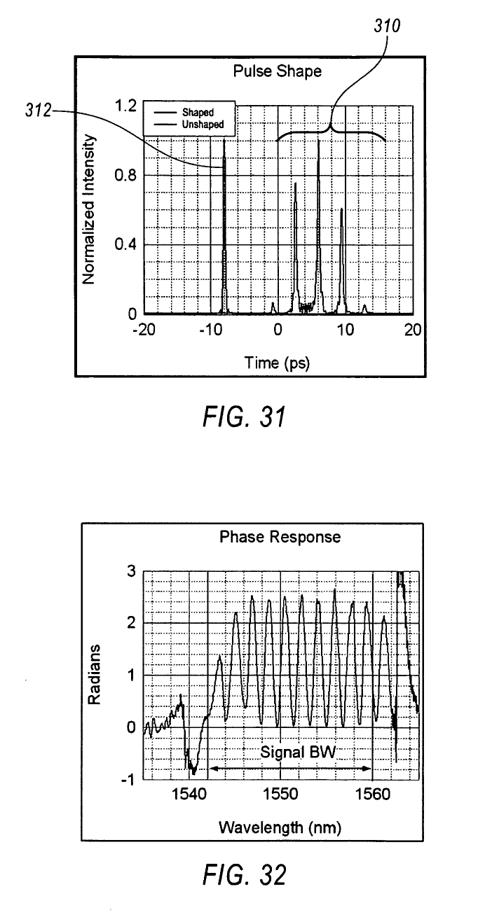

In addition to simply applying a steady state force to tunable chirped fiber grating 28, actuators 62 may be controlled and modulated in a periodic fashion. FIG. 31 shows an input pulse 312 and an output pulse 310 where actuators 62 are driven in a sinusoidal driving profile.

FIG. 32 shows the phase response where the input pulse is split into a pulse train by applying sinusoidal actuator driving profile for twenty nanometer (20 nm) bandwidth signal. A direct current (DC) (e.g., steady state) driving profile narrows the signal bandwidth.

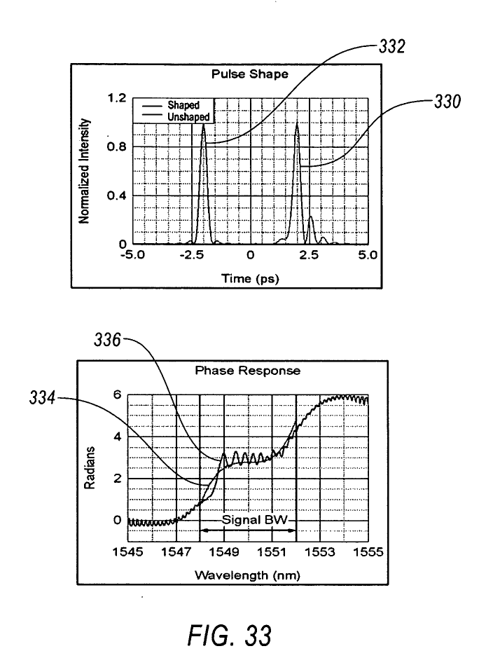

FIG. 33 shows a pulse shape and phase response for a four nanometer (4 nm) bandwidth (BW) signal for an input pulse 332 (having an input phase response 336) and an output pulse 330 (having an output phase response 334).

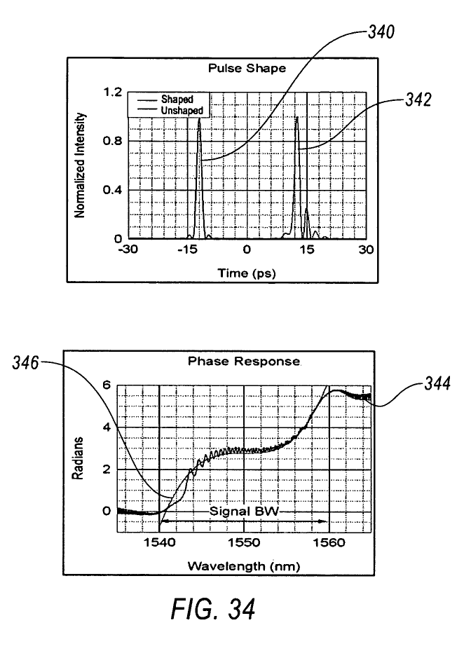

FIG. 34 shows a pulse shape and phase response for a twenty nanometer (20 nm) BW signal for an input pulse 342 (having an input phase response 346) and an output pulse 340 (having an output phase response 344).

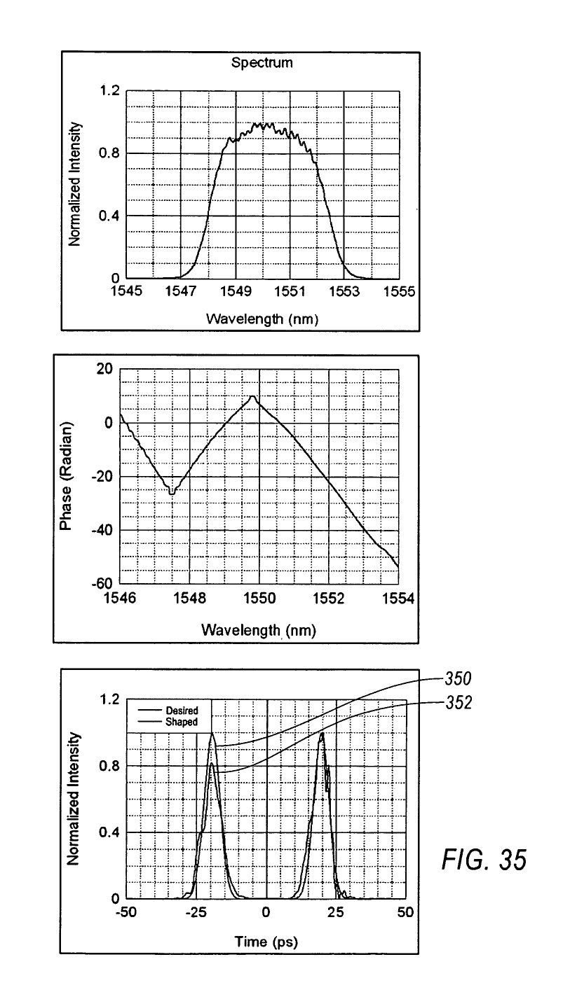

FIG. 35 shows an example of creating a desired pulse shape 350 by finding a required phase response of the grating through an iterative Fourier transform algorithm using the system of FIG. 1. Given a power spectrum density, pulse shaping (e.g., shaped pulse 352) is achieved by changing the relative phase of different spectral components. Each pulse is eight picoseconds (8 ps) wide and the pulses are fourth picoseconds (40 ps) apart.

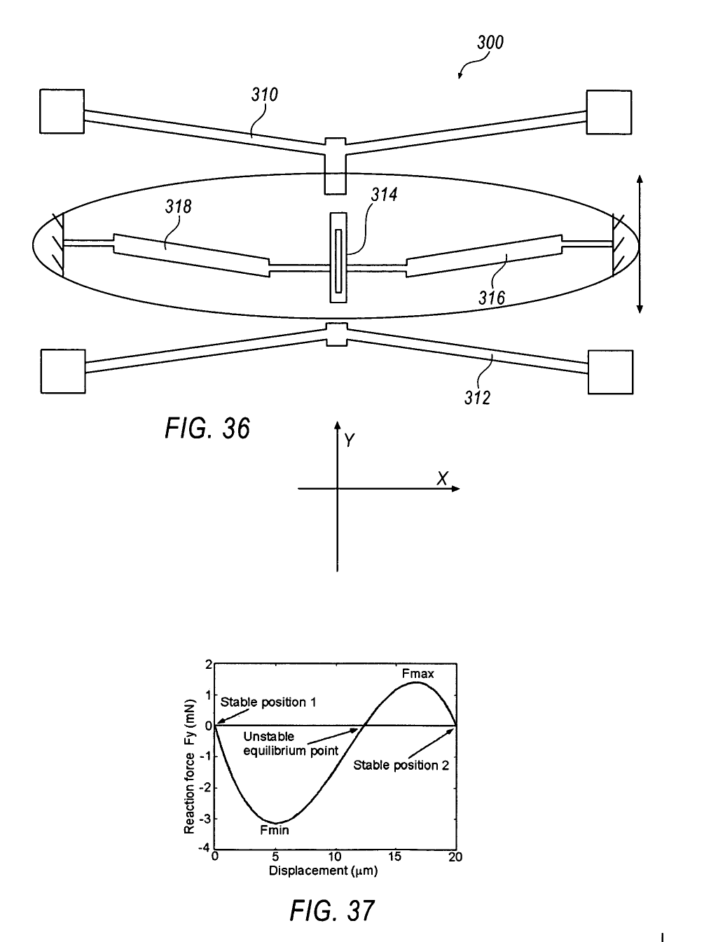

FIG. 36 shows an alternative embodiment of actuator 62 that is a bistable latching mechanism 300. Also a MEMS device, bistable latching mechanism defines several positions where latching occurs. By using a latching actuator, e.g., bistable latching mechanism 300, a tunable chirped fiber grating 28 (see FIG. 1) may be used either arbitrarily as controlled, or it may be configured and removed from power. Using the bistable latching mechanism 300, the strains imparted on tunable chirped fiber grating 28 will remain even if bistable latching mechanism 300 is left unpowered. Bent-beam electro-thermal actuators 310, 312 selectively move a central body 314 substantially perpendicular to holding arms 316, 318. When one of bent-beam electro-thermal actuator 310 is moved by passing a current therethrough, central body 314 is pushed away in a first direction. When the opposite bent-beam electro-thermal actuator 312 is moved, central body 314 is pushed back to the original location. In this way, bent-beam electro-thermal actuators 310, 312 may selectively move central body 314 to a resting position.

FIG. 37 shows a reaction force/displacement curve for bistable latching mechanism 300 of FIG. 36. The bistable structure can be switched between stable position 1 and stable position 2 by bent-beam electro-thermal actuators 310, 312. The latching force is in the milliNewton (mN) force range.

In the embodiments disclosed herein, an integrated on-chip optical pulse shaper suitable for programmable waveform generation with femtosecond (fs) or picosecond (ps) pulses is described. Good correspondence exists between numerically predicted and experimentally observed chirped fiber grating spectral responses to the action of an electrothermal actuator. This demonstrates that accurate and reproducible optical control has been achieved using the apparatuses and methods described herein. Advantages of this technique go beyond its practical aspect of being very compact and robust. Indeed, this approach allows selecting narrow or broad spectral bandwidths irrespective of chirped grating size, thus permitting pulse-shaping on picosecond (ps) as well as nanosecond (ns) time-window scales. Also, this device can provide for exceptionally large phase shifts, thus permitting programmable compensation of large amounts of dispersion as well as programmable control of large time-delay values. More generally, the demonstrated approach of MEMS-control of internal fiber properties can be extended to other types of devices, such as fiber couplers, long-period gratings, etc., thus enabling a new broad class of functionally-diverse fiber-MEMS integrated devices. Moreover, there is also the option of providing a programmable waveform generator with a power-off mode using a MEMS latching design.

Control of optical wave shaping system 20, and in particular actuator array 60, may be accomplished by simulation to determine the desired control voltage for each of micro-actuators 62. Using for a Genetic Algorithm (GA), a Simulated Annealing and Simplex Downhill algorithm (SASD), or, in a preferred embodiment, an Iterative Fourier transform algorithm (IF), simulation of optical wave shaping system 20 can be performed. Given the results of the aforementioned algorithms, the driving voltage for each micro-actuator 62 that was determined in simulation is then applied to each micro-actuator 62.

Alternatively optical wave shaping system 20 may be used in an iterative fashion to generate waveforms and with different applied voltages, the output waveform may be improved toward a target. In this way, optical wave shaping system 20 uses programmable pulse shaping to change the output waveform iteratively in real-time to seek the best response for a particular desired application. Given a target waveform, optical wave shaping system 20 generates an approximate version and then through feedback improves the output over successive attempts.

Chirped fiber grating represented in the detailed implementation example is a short-period reflection grating, i.e. output signal is produced in reflection with respect to the grating since the period is comparable to optical wavelengths and can fulfill Bragg condition for these optical wavelengths. In general, other types of grating can be used, for example long-period chirped gratings (where period is much longer than optical period) which produce output signal in transmission, i.e. in the same direction as the input signal. In a fiber such gratings can be designed to couple either between different fiber modes, or from a fiber core into a fiber cladding, or between different polarization modes. Furthermore, it is important to note that dual-core fibers can be also used, where chirped gratings (either short-period reflection or long-period transmission) would act as coupling devices between the cores, as commonly used in telecommunication devices.

Furthermore, chirped gratings of the present invention could also be replaced with unchirped gratings. In general addition of MEMS actuators to such grating devices is valuable as means to control optical response of various grating devices.

The present invention has been particularly shown and described with reference to the foregoing examples, which are merely illustrative of the best modes for carrying out the invention. It should be understood by those skilled in the art that various alternatives to the examples of the invention described herein may be employed in practicing the invention without departing from the spirit and scope of the invention as defined in the following claims. The examples should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. In sum, it should be understood that the invention is capable of modification and variation and is limited only by the following claims.

The present embodiments have been particularly shown and described, which are merely illustrative of the best modes. It should be understood by those skilled in the art that various alternatives to the embodiments described herein may be employed in practicing the claims without departing from the spirit and scope as defined in the following claims. It is intended that the following claims define the scope of the invention and that the method and apparatus within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A fiber, comprising:
a fiber grating; and
at least one refractive index modifier interfacing said fiber grating, said at least one refractive index modifier selectively introducing a refractive-index change on said fiber grating.

2. The fiber of claim 1, wherein said refractive index modifier comprises at least one actuator.

3. The fiber of claim 2, wherein said at least one actuator is a plurality of actuators, said fiber grating further comprising a plurality of spectral portions, and said plurality of actuators interfaces with said spectral portions.

4. The fiber of claim 2, wherein each of said plurality of actuators is individually controllable to introduce said refractive-index change on said fiber grating.

5. The fiber of claim 2, wherein each of said plurality of actuators introduce a force on the cladding of said tunable fiber grating.

6. The fiber of claim 2, wherein each of said plurality of actuators controllable introduces a variable strain on said fiber grating.

7. The fiber of claim 1, wherein said fiber grating comprises a chirped fiber grating.

8. The fiber of claim 2, wherein said at least one actuator is a micro-machined actuator.

9. The fiber of claim 8, wherein said micro-machined actuator is a bent-beam actuator.

10. The fiber of claim 2, wherein said at least one actuator is a plurality of micro-machined actuators interfacing said fiber grating.

11. The fiber of claim 10, wherein each of said micro-machined actuators is individually controllable to introduce strain on said fiber grating.

12. The fiber of claim 10, wherein at least one of said micro-machined actuators is operated in bi-stable mode and retains the last controlled position.

13. An optical pulse shaper, comprising:
a first optical circulator having a first port, a second port, and a third port; and
an adjustable fiber grating in optical communication with said second port, whereby an optical pulse enters said first port and exits said third port as a shaped pulse.

14. The optical pulse shaper of claim 13, further comprising at least one refractive index modifier selectively introducing a localized refractive-index change to said adjustable fiber grating.

15. The optical pulse shaper of claim 13, further comprising an actuator array selectively introducing at least one localized refractive-index change to said adjustable fiber grating.

16. The optical pulse shaper of claim 13, wherein said adjustable fiber grating comprises a compressing fiber Bragg grating.

17. The optical pulse shaper of claim 16, further comprising:
an second optical circulator having a fourth port, a fifth port, and a sixth port;
a stretching fiber grating in communication with said fourth port, wherein said sixth port is optically connected with said first port of said first optical circulator, whereby said second optical circulator receives an optical input pulse at said first port and provides said optical pulse to said first optical circulator.

18. The optical pulse shaper of claim 13, wherein said adjustable fiber grating further comprises a plurality of actuators, each of said plurality of actuators being independently controllable to introduce strain into said fiber grating.

19. The optical pulse shaper of claim 13, wherein said adjustable fiber grating further comprises a plurality of force producing actuators, each of said plurality of force producing actuators introducing mechanical strain into said fiber grating.

20. The optical pulse shaper of claim 19, wherein said plurality of force producing actuators are evenly spaced along the cladding of said fiber grating.

21. The optical pulse shaper of claim 19, wherein said plurality of force producing actuators are actuated by providing an electric stimulus.

22. The optical pulse shaper of claim 19, wherein said plurality of force producing actuators are actuated by providing an electric stimulus.

23. A method of tuning a fiber grating, comprising:
selectively locally modifying a portion of said fiber grating.

24. The method of claim 23, wherein said step of selectively locally modifying includes applying force to the outer cladding of a fiber.

25. The method of claim 23, wherein said step of selectively locally modifying includes introducing a strain to said fiber grating.

26. The method of claim 23, further comprising:
selectively locally modifying a plurality of portions of said fiber grating, wherein said selectively locally modifying is independently controllable for each of said plurality of portions.
